(19) United States
(12) Patent Application Publication
(10) Pub. No.: US 2024/0012198 A1
(43) Pub. Date: Jan. 11, 2024

(54) UNIVERSAL LINEAR OPTICAL DEVICE

(71) Applicant: Research Foundation of the City University of New York, New York, NY (US)

(72) Inventors: Mohammad-Ali Miri, Plainview, NY (US); Kevin Dagoberto Zelaya Mendoza, New York, NY (US)

(21) Appl. No.: 18/350,538

(22) Filed: Jul. 11, 2023

Related U.S. Application Data
(60) Provisional application No. 63/359,994, filed on Jul. 11, 2022.

(51) Int. Cl. G02B 6/12

(52) U.S. Cl. CPC G02B 6/12011; G02B 6/12016; G02B 2006/12147; G02B 2006/121

(57) ABSTRACT

A device for performing unitary matrix computations comprises a light source configured to generate first optical signals; an array of waveguides, including: inputs that receive the first optical signals from the light source; a plurality of channels positioned in parallel for transmitting the first optical signals along a length of the waveguides; and outputs for outputting second optical signals generated according to a matrix multiplication operation from the first optical signals. The device further comprises phase shifters constructed and arranged in a cascade structure at the channels of the waveguides, the waveguides include sections or directional couplers between adjacent phase shifter. The matrix multiplication operation includes coupling coefficient values between adjacent waveguides and length values of the sections of the waveguides. General non-unitary matrix computations are implemented by interlacing two embodiments of the device together with an array of amplitude modulators.

### RELATED APPLICATIONS

This application claims priority to U.S. Provisional Application Serial No. 63/359,994 filed Jul. 11, 2022, entitled “UNIVERSAL LINEAR OPTICAL DEVICE,” the entirety of which is incorporated by reference herein.

### STATEMENT REGARDING FEDERALLY FUNDED RESEARCH OR DEVELOPMENT

This invention was made with government support under grant number FA9550-22-1-0189 awarded by Air Force Office of Scientific Research. The government has certain rights in the invention.

### FIELD OF THE INVENTION

The present invention relates generally to programmable integrated optical circuits. In particular, the invention relates to devices for performing universal linear optics transformations on waveguides.

### BACKGROUND

Advances in deep learning technology require an increased demand for computing power. Photonic devices that can perform an arbitrary linear operation on modulated light are an important component for quantum mechanics and classical information processing. A photonic matrix-vector multiplier is a key element for implementing analog neural networks with photonic circuits. In addition, such a component provides a platform for multistate systems of quantum particles for quantum computation and quantum information processing. On the other hand, an integrated matrix-vector multiplier is intrinsically a universal multiport feed-forward optical device with a wide range of applications such as integrated switching, filtering, and mode division multiplexing/demultiplexing, but not limited thereto. This becomes particularly important when a linear optical device becomes reconfigurable to implement photonic devices for a wide range of applications from classical and quantum information processing to sensing and metrology or other science and quantum technologies.

### SUMMARY

In one aspect, provided is an optical device for performing unitary matrix computations comprises a light source configured to generate first optical signals; an array of waveguides, including: inputs that receive the first optical signals from the light source; a plurality of channels positioned in parallel for transmitting the first optical signals along a length of the waveguides; and outputs for outputting second optical signals generated according to a matrix multiplication operation from the first optical signals. The optical device further comprises phase shifters constructed and arranged in a cascade structure at the channels of the waveguides, the waveguides include sections or directional couplers between adjacent phase shifters. The matrix multiplication operation includes coupling coefficient values between adjacent waveguides and length values of the sections of the waveguides.

In another aspect, a scaled-up photonic device for performing general non-unitary matrix computations, comprises a light source configured to generate a plurality of first optical signals (see claim 1); two N×N optical devices performing a unitary matrix multiplication from the first optical signals; and an array of amplitude modulators interlaced between the two unitary matrix multiplication devices.

In another aspect, a method for finding parameters that realize a desired optical matrix-vector multiplier comprises executing a gradient-based optimization method to find the parameters that minimize a L₂-norm of the difference between a target matrix and an approximation produced by the factorized matrix in Eq. (1) for the corresponding parameters according to the case-I or case-II herein.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 is a schematic diagram of a linear unitary optical device, in accordance with some embodiments.

FIG. 2 is a schematic diagram of a waveguide array, in accordance with some embodiments.

FIG. 3 is a schematic diagram of a phase shifter array, in accordance with some embodiments.

FIG. 4 is a flow diagram of a systematic design algorithm for finding parameters involved for realizing a desired matrix-vector multiplier.

FIG. 5 is a flow diagram of a method for identifying optimal parameters for a large unitary matrix, in accordance with some embodiments.

FIG. 6 is a schematic diagram of a universal linear optical device that can perform arbitrary matrix-vector multiplication, in accordance with some embodiments.

### DETAILED DESCRIPTION

In brief overview, the present inventive concept provides a real-time matrix-vector multiplication apparatus and method that are useful for classical and quantum optical information processing applications, especially with respect to photonic acceleration in artificial intelligence and neural networks. In classical computing, matrix-vector multipliers are core for developing photonic chips for unconventional computing with photonic spin simulators, neuromorphic computing, and machine learning with analog photonic neural networks. In quantum information processing and quantum machine learning, a similar functionality is required for performing linear operations in photonic integrated circuits that manipulate quantum states of light. In addition to applications in optical computing, a photonic device having a multiplier can serve as a universal multi-input, multi-output device for ultra-high-speed manipulation of light in photonic integrated circuits for a broad spectrum of purposes ranging from analog optical signal processing to metrology and sensing and involve applications in telecommunication and light detection and ranging (LiDAR), but not limited thereto.

As previously mentioned, matrix-vector multipliers are important for neural networks. Deep learning extends on machine learning by using more-complex neural networks to tackle more-complex tasks, including speech recognition and autonomous driving. However, deep learning requires processing large volumes of data using complex processes such as matrix vector multiplication. In order to keep up with the increasing demand for increases in processing, developers are looking to universal linear optical devices.

This disclosure describes photonic integrated circuits that perform analog matrix-vector multiplications with light. A universal photonic device that can perform arbitrary linear operations is an indispensable component of classical and quantum optical computing, while it also serves as a critical multiport circuit for advanced manipulation of light in photonic integrated circuits. One of the main limitations of the existing integrated photonic matrix multipliers is their relatively large (compared to the wavelength of light) feature sizes which prevents their scaling to large numbers of ports. The existing solutions are based on integrated Mach-Zehnder interferometers, which are inherently bulky elements.

In accordance with embodiments, provided is a novel architecture for realizing compact photonic circuits that perform arbitrary complex linear operations by interlacing or cascading two building blocks: waveguides and phase shifters. Thus, non-unitary matrix computations can be implemented by interlacing an array of amplitude modulators between two unitary matrix multiplication devices. By utilizing this architecture, a scalable and energy-efficient integrated photonic circuits that perform arbitrary complex linear operations with light is provided. Furthermore, by incorporating tunable phase shifters, a programmable photonic circuit for general-purpose applications is realized.

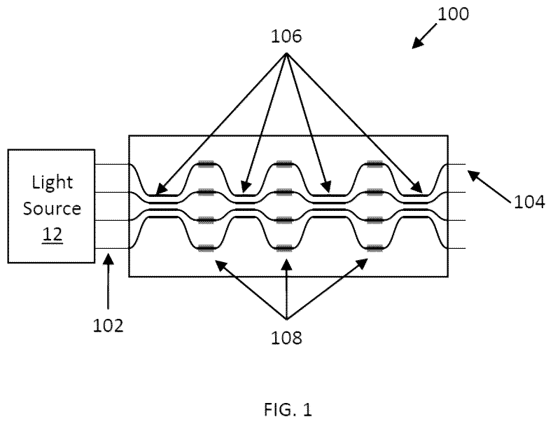

FIG. 1 is a schematic diagram of a universal linear optical device 100, in accordance with some embodiments. In some embodiments, the universal linear optical device 100 is constructed and arranged to perform photonic matrix computations, or more specifically, includes a photonic matrix-vector multiplier for accelerating computing in the optical domain for signal processing and artificial intelligence algorithms, but not limited thereto. The optical device can be formed at least in part as an integrated optic circuit, used to multiply an N input vector (A) and an N×N matrix (B) to produce a new N output vector, or a matrix-vector product C, represented mathematically as C=A·B, with the symbol “·” denoting the conventional matrix multiplication operation.

In some embodiments, the optical device 100 includes a plurality of evanescently-coupled optical waveguides 106 and cascaded layers of phase elements 108, such as phase modulators, shifters, or the like, constructed and arranged in an array, for example, an N×N array formed of N input ports and N output ports, where N is an integer greater than 1. In some embodiments, the optical waveguides 106 and phase elements 108 are integrated into a single photonic chip and constructed and arranged for arbitrary linear operations.

The optical waveguides 106 are coupled to a light source 12, or in some embodiments, a beam splitter. The input ports 102 and output ports 104 of the waveguides 106 are arranged as N×1 arrays. In some embodiments, each waveguide 106 may include at least one modulator for encoding amplitude and phase information for the optical signals transmitted through the waveguide.

The phase elements 108 are integrated into a single photonic chip that is electrically and optically interfaced for settings of the phase elements 108. The phase elements 108 are arranged along the waveguides 106, and more specifically, positioned at waveguide sections with different lengths for rebalancing loads between the parallel waveguides 106. The waveguide sections or layers may be referred to as directional couplers. In some embodiments, the phase shifters are cascaded in series and can be calibrated accordingly to achieve a desired phase resolution. For example, the phase elements 108 are tunable to establish a relative phase shift of the optical signals required to compute matrix-vector multiplications. The phase elements 108 modulate the phase only of a transmission wave along a waveguide 106 without changing the amplitude, so that the total of amplitudes of the optical signals is maintained along the length of the channels. The power tuning function can be obtained by the phase elements 106 to form the arbitrary linear optical device.

The light source 12 encodes the input vector A to be multiplied. This is generated from a monochromatic light source injected into an array of Mach-Zehnder interferometer that splits the signal into the N required components of A. During operation, input vectors are loaded on a wavelength generated by the light source 12. The optical device 100 represents the unitary matrix B that performs a linear matrix operation on the complex modal amplitudes of light at the input ports 102 (A) to create the complex modal amplitudes of light at the output ports 104 (C=B·A). The lengths of the waveguide layers and the phase of the phase shifters are predetermined so that the device can perform a desired unitary matrix operation U. See Eq. (1) below.

To implement an arbitrary linear unitary operation U acting on N optical modes to perform an N×N matrix operation, a cascaded series of phase elements 108 are utilized. In doing so, M-1 layers of phase modulations are considered (each containing N phase elements) and sandwiched between M waveguide sections with different lengths. Here, M is fixed so that the minimum total number of parameters (N²) to be optimized is met or exceeded (overdetermined problem). The design is based on the hypothesis that an arbitrary unitary matrix can be decomposed in the form:

U=e^{iP}^{_{M}}e^{iQ}^{_{M-1}}e^{iP}^{_{M-1}}. . . e^{iQ}^{₂}e^{iP}^{₂}e^{iQ}^{₁}e^{iP}^{₁} (1)

where, the matrices e^{iP}^{ₘ}(m=1, . . . , M) and e^{iQ}^{ₘ}(m=1, . . . , M−1), respectively describe the m^{th} layer of the waveguide sections and the phase modulation planes. Moreover, the following matrices in Eq. (1) are used:

$${P}_{m} = {ℓ}_{m} [ \begin{matrix}0 & {κ}_{1 , 2}^{m} & ⋯ & 0 \\ {κ}_{1 , 2}^{m} & 0 & ⋱ & ⋮ \\ ⋮ & ⋱ & ⋱ & {κ}_{N - 1 , N}^{m} \\ 0 & … & {κ}_{N - 1 , N}^{m} & 0\end{matrix} ] , {Q}_{m} = [ \begin{matrix}{ϕ}_{1}^{m} & 0 & ⋯ & 0 \\ 0 & {ϕ}_{2}^{m} & ⋱ & ⋮ \\ ⋮ & ⋱ & ⋱ & 0 \\ 0 & … & 0 & {ϕ}_{N}^{m}\end{matrix} ] . \qquad ( 2 )$$

Here, ϕₙ^{m}(n=1, . . . , N and m=1, . . . , M−1) represent the phases imposed by the N phase elements in the m^{th} layer, [symbol] ₘ represent the length of the coupled waveguide sections and κ_{n,n+1}^{m}(n=1, . . . , N−1 and m=1, . . . , M−1) is the distributed coupling rate between two adjacent waveguides n and n+1 in the m^{th} layer.

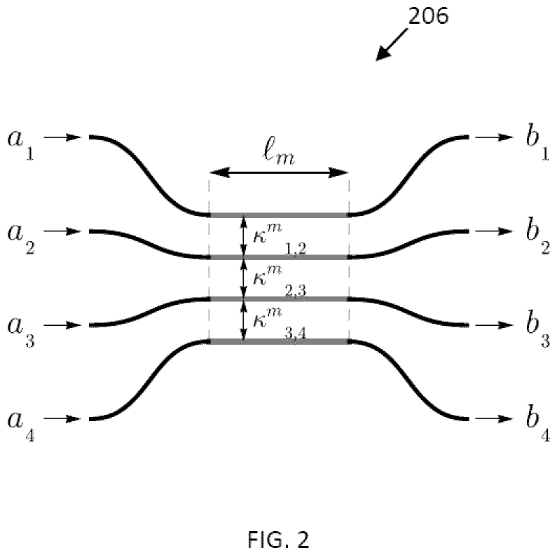

As shown in FIG. 1, the two main components of the optical device 100 are coupled waveguide arrays 206 and phase modulator arrays 308. FIG. 2 is a schematic diagram of a waveguide array 206, which may include a plurality of waveguides 106 of FIG. 1, in accordance with some embodiments. The waveguide arrays 206 are composed of an array of optical dielectric waveguides 106 that are positioned in parallel and in proximity such that light from each channel can evanescently couple to adjacent channels. The coupling coefficient κ between each two adjacent waveguides 106 are considered different, as shown in FIG. 2. By considering the length of a waveguide section being [symbol] ₘ, the input and output values of this waveguide array 206 become related according to the following relation:

$$[ \begin{matrix}{b}_{1} \\ {b}_{2} \\ ⋮ \\ {b}_{N}\end{matrix} ] = {e}^{{iP}_{m}} [ \begin{matrix}{a}_{1} \\ {a}_{2} \\ ⋮ \\ {a}_{N}\end{matrix} ] , \qquad ( 3 )$$

where it is convenient to use the equivalent definition

$${P}_{m} = [ \begin{matrix}0 & {θ}_{1}^{m} & ⋯ & 0 \\ {θ}_{1}^{m} & 0 & ⋱ & ⋮ \\ ⋮ & ⋱ & ⋱ & {θ}_{N - 1}^{m} \\ 0 & … & {θ}_{N - 1}^{m} & 0\end{matrix} ] , {θ}_{n}^{m} = {κ}_{n , n + 1}^{m} {ℓ}_{m} . \qquad ( 4 )$$

with θₙ^{m} parameters to be optimized.

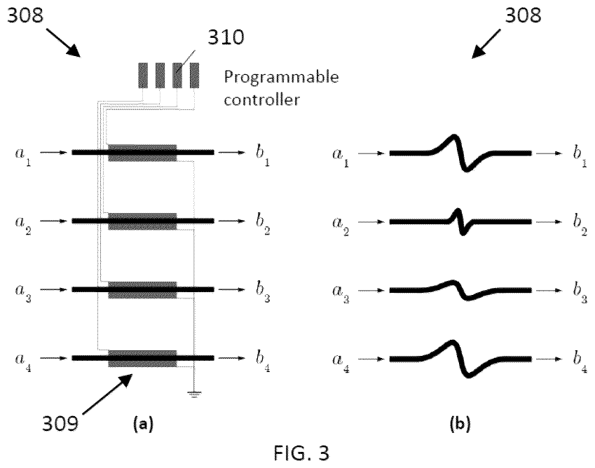

FIG. 3 is a schematic diagram of a phase shifter array 308, which may include a plurality of phase elements 108 of FIG. 1, in accordance with some embodiments. Particularly, FIG. 3(a) shows the phase element for a class of tunable (active) phase shifters 308 that are controlled electrically via a programmable interface controller 310. Such phase shifters are based on thermo-optical effects and composed of a metal heater element 309 placed on top of the waveguide 106 to be tuned. The metal plates forming the heater element 309 receive a specific voltage independently, generating thermal heat that alters the refractive index of the waveguide 106 as needed, and consequently producing the required phase shift. In turn, FIG. 3(b) depicts the case of non-tunable (passive) phase element produced by deliberately extending the waveguide effective path so that a total phase is accumulated. This does not tolerate any modification once manufactured and produces a unique phase delay.

The phase shifter array 308 is described through the following input-output relation:

$$[ \begin{matrix}{b}_{1} \\ {b}_{2} \\ ⋮ \\ {b}_{N}\end{matrix} ] = {e}^{{iQ}_{m}} [ \begin{matrix}{a}_{1} \\ {a}_{2} \\ ⋮ \\ {a}_{N}\end{matrix} ] , \qquad ( 5 )$$

where,

$${Q}_{m} = [ \begin{matrix}{ϕ}_{1}^{m} & 0 & ⋯ & 0 \\ 0 & {ϕ}_{2}^{m} & ⋱ & ⋮ \\ ⋮ & ⋱ & ⋱ & 0 \\ 0 & … & 0 & {ϕ}_{N}^{m}\end{matrix} ] . \qquad ( 6 )$$

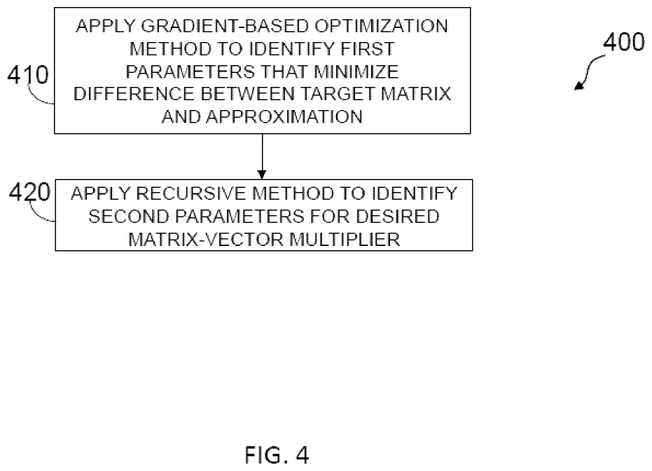

The desired multiplicative unitary matrix B=Uₜ to represent the unitary matrix-vector product C=B·A is defined. Henceforth, Uₜ is interchangeably referred to as a target matrix. The device 100 is capable of represent the target matrix, provided that the appropriate parameters are identified, such as the phase elements, waveguide section lengths and coupling parameters. FIG. 4 is a flow diagram of a systematic design algorithm 400 for finding parameters involved for realizing a desired matrix-vector multiplier. The systematic design algorithm 400 is stored in a memory and executed by at least one processor, for example, a special-purpose computer-based device. The coupling coefficients κ_{n,n+1} of the waveguide array 206 in consideration must be determined (case-I below) or yet to be found (case-I below) depending on the desired parameterization of the target matrix. These couplings shall be non-null and the respective waveguide array lengths [symbol] ₘ are yet to be found.

Be the set of phases ϕ={ϕₙ^{m}}_{n=1,m=1}^{N,M-1}, waveguide parameters θ={θₙ^{m}}_{n=1,m=1}^{N-1,M}, and waveguide array lengths [symbol] ={ [symbol] ₘ}ₘ₌₁^{M}, along with the L₂-norm (also known as Frobenius norm) ∥F∥:=\sqrt{tr(FF^{†})} associated with a given complex-valued matrix F. Two different optimizations can be performed to parametrize the target matrix Uₜ, denoted Case-I (see method 500A) and Case-II (see method 500B) as follows:

Case-I: The factorized matrix in Eq. (1) is parametrized in terms of the sets θ and ϕ as U(θ, ϕ), where ϕₙ^{m}∈(−π, π) and θₙ^{m}∈ [symbol] . This leads to 2NM−(N+M) parameters to optimize. That is, the product of waveguide section lengths with the coupling parameters θₙ^{m}= [symbol] ₘκ_{n,n+1} and phase modulations ϕₙ^{m} must be determined.

Case-II: The factorized matrix in Eq. (1) is parametrized in terms of the sets [symbol] and ϕ as U( [symbol] , ϕ), where ϕₙ^{m}∈(−π, π) and [symbol] ₘ>0. This leads to M(N+1)−N parameters to optimize. That is, the waveguide section lengths [symbol] ₘ and phase modulations ϕₙ^{m} must be determined.

At step 410, a gradient-based optimization method is executed to find the parameters that minimize the L₂-norm of the difference between the target matrix and the approximation produced by the ansatz of relation Eq. (1). That is,

$$L ( θ , ϕ ) = \frac{‖ U ( θ , ϕ ) - {U}_{t} ‖}{\sqrt{N}} and L ( ℓ , ϕ ) = \frac{‖ U ( ℓ , ϕ ) - {U}_{t} ‖}{\sqrt{N}}$$

for the case-I and case-II, respectively. The L₂-norm of a vector can be used for calculating the error in machine learning models. Numerical results show that a general unitary matrix with up to N=10 can be approximated with the factorization of the form (1) while the error becomes arbitrarily small by increasing the number of optimization iterations.

At step 420, assuming the existence of a factorization of the form (1), a systematic technique can be applied for finding the set of parameters {θₙ^{m}, ϕₙ^{m}} or { [symbol] ₘ, ϕₙ^{m}} for the case-I and case-II, respectively. This can be achieved by identifying a recursive method for reducing the rank of the factorized elements.

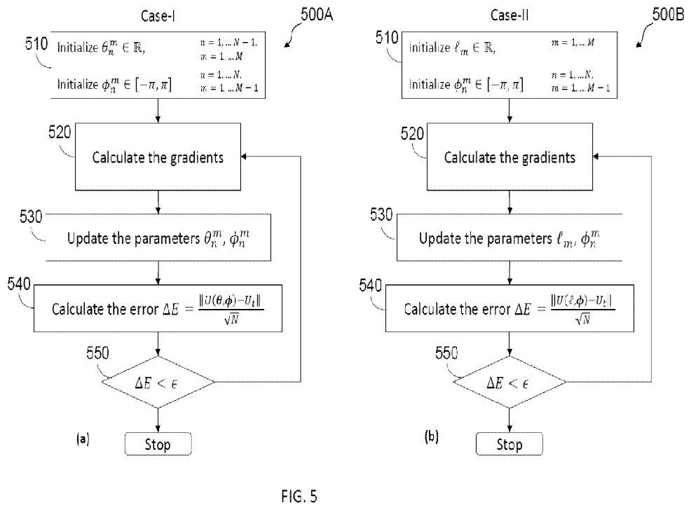

FIG. 5 is a flow diagram of methods 500A and 500B for identifying optimal parameters for a large unitary matrix for both optimizations described in the case-I and case-II, respectively, in accordance with some embodiments. In some embodiments, the methods 500A, 500B (generally, 500) are gradient-descent methods inspired by backpropagation in feedforward neural networks that can be fast and efficient for finding the optimal parameters for large unitary matrices. Gradient-descent optimization techniques are well-known for use in training neural networks.

At step 510, the set of parameters of method 500A {θₙ^{m}, ϕₙ^{m}} or method 500B { [symbol] ₘ, ϕₙ^{m}} are initialized by randomly assigning their values within their domain, as described above. In some embodiments, the unitary matrix can have a value of N=10, but not limited thereto.

At step 520, the gradients are calculated.

At step 530, the parameters {θₙ^{m}, ϕₙ^{m}} or { [symbol] ₘ, ϕₙ^{m}} are updated.

At step 540, a matrix norm is calculated, for example, according to:

$$Δ E = L ( θ , ϕ ) = \frac{‖ U ( θ , ϕ ) - {U}_{t} ‖}{\sqrt{N}} or Δ E = L ( , ϕ ) = \frac{‖ U ( ℓ , ϕ ) - {U}_{t} ‖}{\sqrt{N}} . \qquad ( 7 )$$

At decision diamond 550, a determination is made whether ΔE<ε. If not, then the recursive method returns to step 520. If yes, then the method ends.

The disclosed device enables analog devices that perform linear discrete operations. In addition, by using controllable phase elements, i.e., by using phase modulators, this device becomes a programmable multiport circuit. Such a device can have a wide range of applications in classical and quantum information processing as discussed in previous sections.

The inventive concept described herein has been intended to work on the optical frequency domain, where waveguide arrays are light carriers and also allow for coupling between neighboring elements. However, the concept is not limited to the optical frequency domain. Nevertheless, other embodiments of the inventive concept can apply to the microwave domain using microstrip lines suitable for microwave transport, and interdigital capacitor for evanescent mode couplings between neighbors. Thus, a microwave device may be provided instead of an optical device.

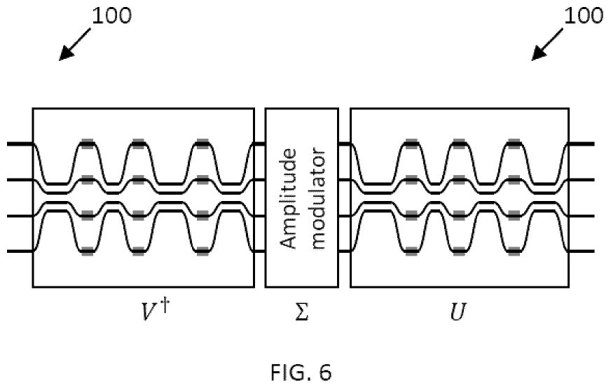

The inventive concept can be scaled-up to perform more general matrix multiplications, i.e., by considering a non-unitary matrix F. This is done using the well-known singular value decomposition F=UΣV^{†}, where U and V^{†} are unitary matrices that can be represented through the invention, and Σ is a positive-definite matrix that can be implemented using amplitude modulators (no phase-modulation required in this layer). Then, the general non-unitary matrix-vector multiplication C=F·A can be implemented, where A is the N input vector and C the N output vector. The scaled-up device is shown in FIG. 6, where two different instances of the device 100 are used.

Accordingly, in some embodiments, two N×N optical devices perform a unitary matrix multiplication operation from the received optical signals that are transmitted through a plurality of waveguides. An array of amplitude modulators are interlaced between the two unitary matrix multiplication devices. A plurality of waveguides for transmitting the first optical signals. For non-unitary operations, total amplitude is not preserved. The modulators are constructed and arranged for encoding amplitude and phase information for the optical signals transmitted through the waveguides.

While the invention has been described with reference to certain embodiments, it will be understood by those skilled in the art that various changes may be made and equivalents may be substituted for elements thereof to adapt to particular situations without departing from the scope of the disclosure. Therefore, it is intended that the claims not be limited to the particular embodiments disclosed, but that the claims will include all embodiments falling within the scope and spirit of the appended claims.

What is claimed is:

1. An optical device for performing unitary matrix computations, comprising:
a light source configured to generate a plurality of first optical signals;
an array of waveguides, including:
a plurality of inputs that receive the plurality of first optical signals from the light source;
a plurality of channels positioned in parallel for transmitting the first optical signals along a length of the waveguides; and
a plurality of outputs for outputting second optical signals generated according to a matrix multiplication operation from the first optical signals, the optical device further comprising a plurality of phase shifters constructed and arranged in a cascade structure at the channels of the waveguides, the waveguides including sections between adjacent phase shifters, wherein the matrix multiplication operation includes coupling coefficient values between adjacent waveguides and length values of the sections of the waveguides.

2. The optical device of claim 1, wherein the number (N) of inputs equals the number (N) of outputs perform an N×N matrix operation, and wherein the cascade of phase shifters includes a plurality (M−1) layers of phase modulations each including N phase shifters positioned between M waveguide sections with different lengths.

3. The optical device of claim 1, wherein the array of waveguides includes an array of optical dielectric waveguides so that when positioned in parallel and in proximity light from each channel evanescently couples to adjacent channels.

4. The optical device of claim 1, further comprising an optical encoder configured to encode an input vector into the first plurality of optical signals, wherein the matrix multiplication operation is performed on the input vector to generate the second optical signals representing an output vector.

5. The optical device of claim 1, wherein the waveguides and phase shifters perform an arbitrary unitary linear transformation of the first optical signals of a first array to the second optical signals of a second array.

6. The optical device of claim 1, wherein the waveguides and phase shifters generate an arbitrary unitary matrix for the matrix multiplication operation.

7. The optical device of claim 1, wherein the matrix multiplication operation further includes a determination of phase values imposed by layers of the cascade structure of the phase shifters, the length values of the sections of waveguides, and/or coupling parameters of required evanescent modes between proximal waveguides.

8. The optical device of claim 1, wherein the total of amplitudes of the first optical signals is maintained along the length of the channels.

9. A scaled-up photonic device for performing general non-unitary matrix computations, comprising:
a light source configured to generate a plurality of first optical signals;
two N×N optical devices performing a unitary matrix multiplication from the first optical signals; and
an array of amplitude modulators interlaced between the two unitary matrix multiplication devices.

10. The scaled-up photonic device of claim 9, further comprising a plurality of waveguides for transmitting the first optical signals, wherein the modulators are constructed and arranged for encoding amplitude and phase information for the first optical signals transmitted through the waveguides.

11. The scaled-up photonic device of claim 9, wherein the number (N) of inputs equals the number (N) of outputs perform an N×N matrix operation, and wherein the modulators include a plurality (M−1) layers of phase modulations each including N phase shifters positioned between M waveguide sections with different lengths.

12. The scaled-up photonic device of claim 9, wherein the waveguides and phase shifters perform an arbitrary unitary linear transformation of the first optical signals of a first array to the second optical signals of a second array.

13. The scaled-up photonic device of claim 9, wherein the waveguides and phase shifters generate an arbitrary unitary matrix for the matrix multiplication operation.

14. The scaled-up photonic device of claim 9, wherein the matrix multiplication operation further includes a determination of phase values imposed by layers of the cascade structure of the phase shifters, the length values of the sections of waveguides, and/or coupling parameters of required evanescent modes between proximal waveguides.

15. A method for finding parameters that realize a desired optical matrix-vector multiplier, comprising:
executing a gradient-based optimization method to find the parameters that minimize a L₂-norm of the difference between a target matrix and an approximation produced by the factorized matrix in Eq. (1) for the corresponding parameters according to the case-I or case-II herein.
